(19) United States
(12) Patent Application Publication
(10) Pub. No.: US 2004/0054679 A1
(43) Pub. Date: Mar. 18, 2004

(54) Remotely invoked metaphonic database searching capability

(76) Inventor: James Ralston, Madison, NJ (US)

Correspondence Address: GLEN E. BOOKS, ESQ., LOWENSTEIN SANDLER PC, 65 LIVINGSTON AVENUE, ROSELAND, NJ, 07068, US

(21) Appl. No.: 10/454,261

(22) Filed: Jun. 3, 2003

Related U.S. Application Data
(60) Provisional application No. 60/385,486, filed on Jun. 4, 2002.

(51) Int. Cl. G06F 7/00

(52) U.S. Cl. 707/100

(57) ABSTRACT

The invention is a method for generating metaphonic tokens from a text database for word identification and comparison for use by one or more users. A metaphonic token database can be generated from a text database. The resulting token database can then be output to one or more users. In a preferred embodiment, it is a method for comparing input text, including one or more words, to a text database including a plurality of words. A metaphonic token database is generated from a text database, and a second set of metaphonic tokens is generated from input text. The metaphonic tokens, generated from the input text, are compared to the metaphonic tokens in the metaphonic token database, representing the text database, for possible matches.

### CROSS REFERENCE TO RELATED APPLICATIONS

This application claims the benefit of U.S. Provisional Application Serial No. 60/385,486, “Remotely Invoked Metaphonic Database Searching Capability”, filed Jun. 4, 2002. The 60/385,486 application is incorporated by reference herein.

### FIELD OF THE INVENTION

The present invention relates to methods for generating metaphonic tokens from a text database, and more particularly for comparing text through the use of metaphonic techniques.

### BACKGROUND OF THE INVENTION

The various branches of government and law enforcement agencies find that it is in the national interest to prohibit banks, financial firms, insurance companies, travel-related firms, importers, exporters, wire transfer companies and other businesses from engaging in transactions or holding assets of certain individuals, governments, vessels, corporations, or other organizations. Entities listed are known as Specially Designated Nationals (SDN). If a firm finds itself possessing assets of a SDN it must seize those assets and report such seizure to the Treasury Department. The penalties for violating OFAC regulations are severe fines and even imprisonment.

OFAC compliance is plagued with complications. Because the list of SDNs is updated irregularly, it is easy for a company to find itself using an out-of-date list. Lists must be downloaded, cleaned, parsed and loaded into a database, usually with considerable human intervention. And, after the list of SDNs is updated, the entire regulated company's existing customer database must be compared to the new list because an existing customer may now be listed as a SDN. It is not enough to simply check new customers against a new list. When a firm has thousands of customers, this can be an arduous task. Sometimes a new list is published while an old list is being checked.

Typically a large firm will have more than one system for transacting business with customers and correspondents. It may have one system for accounting, another list of vendors, a different system for SWIFT and GIFTS messaging, and yet another for wire transfers. Recently merged or newly acquired firms may have duplicate systems for years. An insurance company may have one system to handle its life insurance and annuity customers and another system to handle its property insurance customers. Retail and business customers may be kept in separate systems.

Each of these systems typically uses a different platform-specific or language specific binary protocol, and the systems will not inter-operate with systems on different platforms or written in different languages. Different systems produce different results and OFAC compliance can be difficult. Different systems often compare their customers against different versions of the OFAC list. And, each of these systems will use a different method of complying. Some systems attempt to overcome this problem with elaborate replication schemes. But, replication introduces a great deal of complexity, latency and multiple points of failure points to the compliance solution.

Many of the SDNs on the OFAC list come from languages that are not based on the modern western alphabet or English phonetic traditions. This makes it impossible to have standard spellings. Consequently, most systems approach OFAC compliance through manual searches. Most of the automated approaches attempt to find literal matches. Literal matches are doomed to failure because transliterations yield several acceptable spellings for many words (Muamar Al-Quadafi has at least 5 different spellings in major American newspapers and Sadam Hussein has at least three).

Some sophisticated systems approach this problem using a Soundex algorithm. Soundex approximates the spelling of a word by producing a number based on the first 4 characters. However, a four byte value is not sufficient to overcome the problems faced in an OFAC search. Soundex does not address word order, similarities in the initial vowel sounds (Il, El, Al; Abraham, Ibramhim; Yousef, Usof), repeated letters or very long name strings. Use of Soundex typically produces so many false positives that reviewers become fatigued vetting the results. The false positives greatly reduce the value of such systems.

Firms that attempt to comply with OFAC find that they have legitimate clients who continually show up as suspicious during searches. Applying OFAC procedures to known legitimate client names wastes time. Good OFAC searches are needed to identify those customers that have been predetermined as allowable. These clients should not be ‘kicked-out’ by the system as suspect. Likewise, companies can add names of entities that they do not want to conduct business with for their own reasons such as, bad checks, poor vendor performance, suspected fraud, etc.

Accordingly, there exists a need for an improved method for searching foreign words and names that does not involve extensive human intervention and overcomes the weaknesses found in literal string and Soundex implementations.

### SUMMARY OF THE INVENTION

The invention is a method for generating metaphonic tokens from a text database for word identification and comparison for use by one or more users. A metaphonic token database can be generated from a text database. The resulting token database can then be output to one or more users.

In a preferred embodiment, it is a method for comparing input text, including one or more words, to a text database including a plurality of words. A metaphonic token database is generated from a text database, and a second set of metaphonic tokens is generated from input text. The metaphonic tokens, generated from the input text, are compared to the metaphonic tokens in the metaphonic token database, representing the text database, for possible matches.

### BRIEF DESCRIPTION OF THE DRAWINGS

The advantages, nature and various additional features of the invention will appear more fully upon consideration of the illustrative embodiments now to be described in detail in connection with the accompanying drawings. In the drawings:

FIG. 1 shows an overview of the system and illustrates how different systems running on different platforms can interact with the invention;

FIG. 2 shows an overview of the basic functional components of the system;

FIG. 2A shows an alternate view of the components of the system;

FIG. 3 shows an overview of the basic steps of the inventive method;

FIG. 4 is a basic flow diagram that illustrating the process by which the system, using OFAC as an example, automatically updates its data from a central and authoritative source;

FIG. 5 is a basic flow diagram that illustrates how the invention responds to a user or system consuming the service to match a single submitted entity;

FIG. 6 is a basic flow diagram that illustrates how the invention responds to a user or system consuming the service to match an entire list of submissions; and

FIG. 7 is a detailed view of the operation of the web service itself.

It is to be understood that the drawings are for the purpose of illustrating the concepts of the invention and are not to scale.

### DETAILED DESCRIPTION

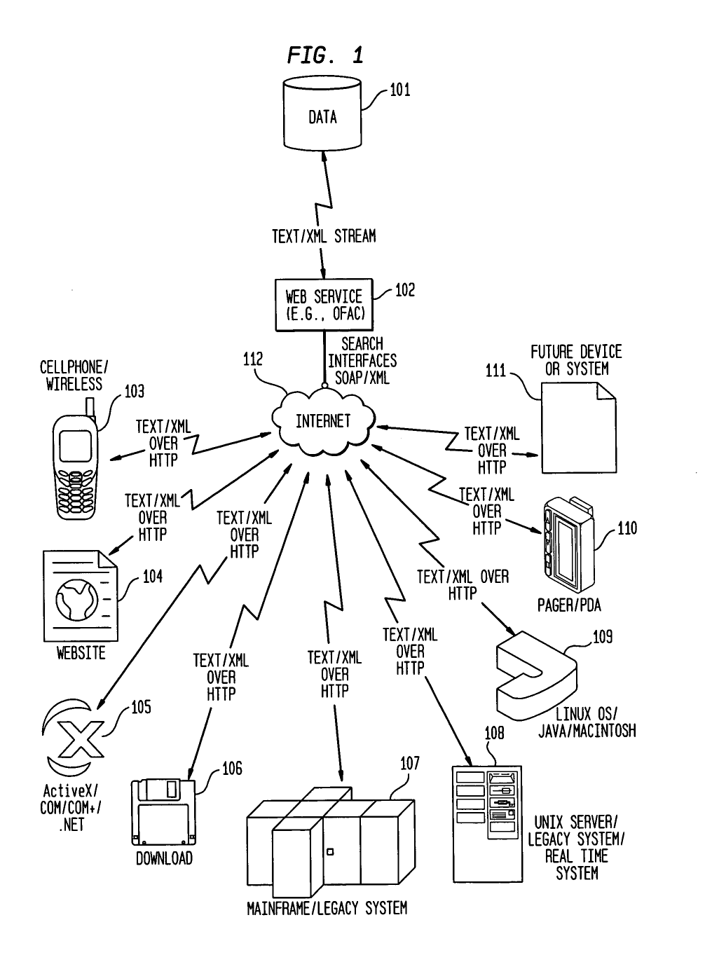

FIG. 1 shows a hardware environment suitable for carrying out the invention. Database 101 updates text comparison service 102 based on metaphonic techniques explained below. Various users can access the service via intranets (not shown) or, more commonly via the Internet 112. Typical devices that can access the service include cell phones and other wireless devices 103, web sites 104, user running Active X,COM, COM+, or NET 105, users who download directly to storage 106, mainframes and other legacy systems 107, UNIX servers, legacy servers, and real time systems 108, LINUX OS, JAVA, and Macintosh based users 109, pager, PDA users 110, and other Internet or Intranet devices as known in the art 111.

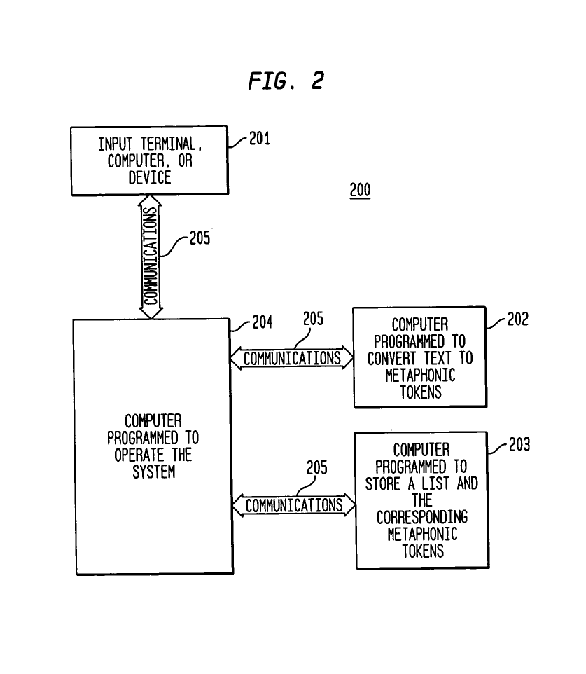

The basic functional blocks of the system 200 are shown in FIG. 2. An input device 201 can be a terminal accessing a system web page via the Internet or a file transfer from a computer. The text or a list of text items to be analyzed by the system can be entered into the system via device 201. Computer 204 runs the system processes. Computer 202 converts the input text to metaphonic tokens. Computer 203 supplies the tokens representing the list to be compared against the actual text of the list for any matched tokens. Matching tokens can be done literally or by measures of closeness. The processes are shown here as running on separate computers for illustrative purposes. The separate computers can be different types of computers, running different operating systems. This is because of the open language communications architecture 205. Alternatively, any combination of the processes can be run on a common computer. FIG. 2A shows the inventive method in an embodiment as web service 250. A text database 251 is accessed by data access method 252. Metaphonic key algorithm 253 creates metaphonic tokens from the items of text in text database 251. A web service consumer can make a request and receive a response through listener 254 (a web server), or browser 257 (a human interface) can make a request and receive a response through presentation layer 255.

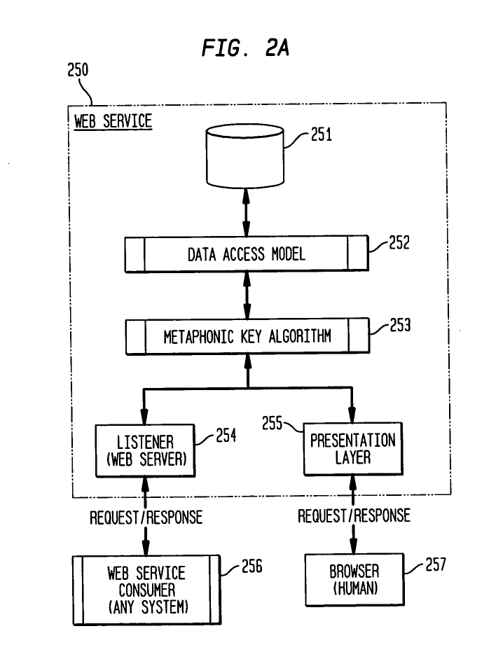

FIG. 3 is a flow diagram that shows the basic steps of the inventive method for comparing one item of text to a list. In step A, text is entered into the system. In step B, an algorithm, the metaphonic algorithm, generates a metaphonic token for the text. This is done per the metaphonic rules such as that described below. A metaphonic algorithm is an algorithm that reduces a word or group of words to a set of tokens that represents the distinct phonetic signatures of those words. The newly generated token is then compared to a list of pre-generated and stored tokens representing the list in step C. Finally in step D, text entries from the list corresponding to any token matches are returned to the user. Some end users may wish to use only the tokens generated by step B and use those tokens in conjunction with other comparison schemes.

According to the present invention, lists of words or names can be efficiently compared to a text item, or list of text items, to be tested against the list. The matching process is done with tokens, also called keys. A token is generated by algorithm for each item in the list and advantageously stored for future comparisons. The algorithm is a metaphonic technique of manipulating characters of text and applying rules to generate metaphonic tokens. Input text, or input lists of text, then generates metaphonic tokens by the same algorithm. The invention can output tokens to an end user as a final product or the invention, or in a preferred embodiment, the tokens generated from the input text are compared to the tokens representing a stored list or database, and matches are returned as the product of inventive system.

Systems and methods consistent with the present invention present sophisticated and customized metaphonic search capabilities as a remotely invoked service that is independent of platform and language. The foregoing description of potential embodiments of the present invention provides context, illustration and description, but is not intended to be exhaustive or to limit the invention to the precise forms discussed and disclosed here. Those skilled in the art will see that modifications, variations and enhancements are possible within the framework of the disclosed invention.

The invention is intended to be used against one or a small number of centrally located databases containing some type of controlling data such as client lists (for conflict searches, customer relationship management, etc.), centralized medical records (drug, patient and donor lists, etc.), restaurants (creatively spelled or foreign names, etc.), or government lists of prohibited entities (OFAC, BXA, etc.) by distributed users and systems of any conceivable type as it is exposed as a Web Service. It works seamlessly with all computer systems and platforms through a human-readable open standard protocol, and uses a powerful metaphonic capability to search a wide variety of databases. A good example of the working of this invention would be its implementation as a tool for companies to comply with Treasury's Office of Foreign Assets Control restrictions on dealings with Specially Designated Nationals.

In addition to returning text matching information, the present invention can provide the inetaphonic key itself as a service. It can also offer variations on the metaphonic key. Some users can opt to only use the system to generate metaphonic keys and then use those keys in their own text matching schemes.

According to the invention, the various parts of the system need not reside the same physical location, or even on the same type of computer platform. This is made possible by remote invocation through open standards as described above. In one working experiment/prototype system, the database was located in New Jersey and the algorithm was run on a different type of server in North Carolina.

The system can advantageously operate by remote invocation. That is users can submit names to the system from remote entry points, such as by internet access. Access, or remote invocation, can also be made through manual or automatic entries on web pages. The remote invocation, a remote procedure call or RPC, uses human readable, ASCII-based set of calls. Responses typically follow the protocols of Simple Object Activation Protocol (SOAP), HTTP and XML (a web service). HTTP GET, HTTP POST and SOAP invocation code that can be used with the present invention is listed in Appendix A. SQL, and similar query languages can be used to perform database interactions. The system can be entirely embedded within other software not contemplated here. It can be implemented in a wide variety of hardware and software embodiments as known to those skilled in the art.

Exemplary Metaphone Algorithm

The metaphone algorithm produces a longer token than Soundex and therefore tends to group names together that are more closely related than Soundex does. Metaphone also tends to produce more matches than Soundex. The metaphone algorithm generates a key value or token for a word based on the significant vowel and consonant audible signatures in that word. Metaphone uses more intelligent transformation rules, though, by examining groups of letters, or diphthongs. The metaphonic algorithm is useful for reducing foreign words, words that have been transliterated or words that are in use in environments where there is significant audible interference or low fidelity.

The metaphone algorithm can be as follows:

1. All non-alphabetic characters are removed from the word.

2. The word is converted to uppercase.

3. All vowels are removed from the word, unless the word begins with a vowel.

4. Consonants are then mapped to their metaphone code.

5. If any consonants except “c” are repeated, the second consonant is removed.

Metaphone encodes sixteen consonant sounds: B X S K J T F H L M N P R O W Y. Please note that X represents the “sh” sound, and O represents the “th” sound.

These following transformations are made at the beginning of a word:

“AE-”, “GN”, “KN-”, “PN-”, “WR-” drop first letter

“X” change to “s”

“WH-” change to “w”

Unless otherwise noted, the following initial vowels are transformed as follows:

A changes to 9

E changes to 9

I changes to 9

O changes to 8

U changes to 8

Y changes to 7

The following transformation rules are used by metaphone after the beginning of the word has been processed. There are two columns and a description for each consonant to be transformed. The first column is the letter to be transformed, the second column is the letter to which it is transformed for the condition given in the description for that transformation. Where there is more than one transformation for a particular letter, the most suitable transformation is that which most closely represents the use of the letter according to the description.

| B | B | unless at the end of word after ″m″, as in ″bomb″ |
|---|---|---|
| C | X | (sh) if ″-cia-″ or ″-ch-″ |
| C | S | if ″-ci-″, ″-ce-″, or ″-cy-″ |
| | | SILENT if ″-sci-″, ″-sce-″, or ″-scy-″ |
| C | K | otherwise, including in ″-sch-″ |
| D | J | if in ″-dge-″, ″-dgy-″, or ″-dgi-″ |
| D | T | otherwise |
| F | F | |
| G | SILENT if in ″-gh-″ and not at end or before a vowel | |
| | | in ″-gn″ or ″-gned″ |
| | | in ″-dge-″ etc., as in above rule |
| G | J | if before ″i″, or ″e″, or ″y″ if not double ″gg″ |
| G | K | otherwise |
| H | SILENT if after vowel and no vowel follows | |
| | | or after ″-ch-″, ″-sh-″, ″-ph-″, ″-th-″, ″-gh-″ |
| H | H | otherwise |
| J | J | |
| K | SILENT if after ″c″ | |
| K | K | otherwise |
| L | L | |
| M | M | |
| N | N | |
| P | F | if before ″h″ |
| P | P | otherwise |
| Q | K | |
| R | R | |
| S | X | (sh) if before ″h″ or in ″-sio-″ or ″-sia-″ |
| S | S | otherwise |
| T | X | (sh) if ″-tia-″ or ″-tio-″ |
| T | 0 | (th) if before ″h″ |
| | | silent if in ″-tch-″ |
| T | T | otherwise |
| V | F | |
| W | SILENT if not followed by a vowel | |
| W | W | if followed by a vowel |
| X | KS | |
| Y | SILENT if not followed by a vowel | |
| Y | Y | if followed by a vowel |
| z | S | |

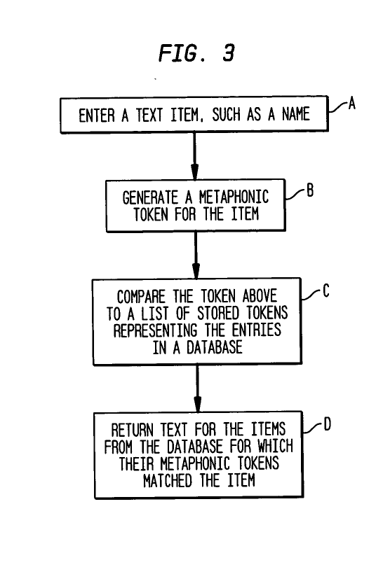

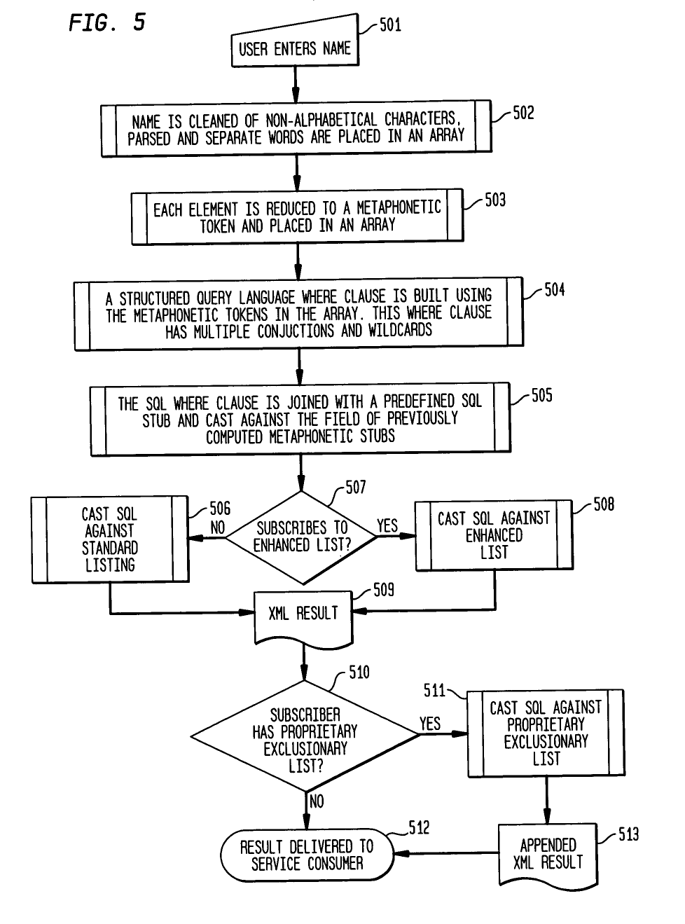

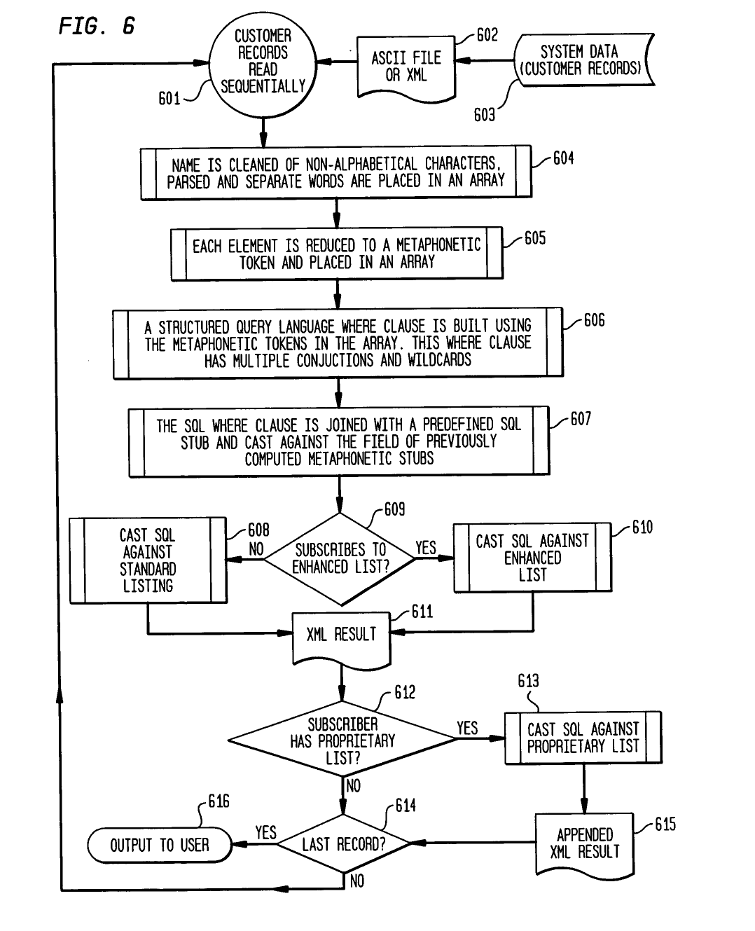

The following lists explain FIGS. 4, 5, and 6 in further detail:

FIG. 4 is a basic flow diagram that illustrating the process by which the system, using OFAC as an example, automatically updates its data from a central and authoritative source. The steps are:

1. The Scheduler 401: A software application for scheduling events such as an operating system service, an out-of process executable or an in process service running within the process space of another application such as a database or file transfer application tracks the passage of time.

2. At some regular interval, Time to check? 402, the scheduler determines if the process for updating the data should run. If yes, the process continues, otherwise it does not and control returns to the scheduler.

3. File management commands are run to clear the permanent storage directory 403 that will receive the pending download of data. If successful, the process continues, otherwise an error message 404 is emailed to the error notification list for attention.

4. A File Transfer Protocol session 405 is opened to the FTP site containing the desired data. The address of the site is stored in persisted form in a database and can be changed when necessary to accommodate changes or to accommodate failure of the primary site.

5. An operating system shell session 406 is opened to run the self-extracting executable archive file if necessary. This decompresses a file containing raw data. If the process is successful the process continues, otherwise an error email 407 is emailed to the error notification list for attention.

6. The system checks 409 to see if the desired file 408 within the compressed set has changed because the file date 410 of the archive might be changed when irrelevant data is modified. After decompressing the archive file, the desired files are checked 409 to see if their dates indicate modification. If the process is successful the process continues, otherwise an error email is emailed to the error notification list for attention 407.

7. The tables containing the now out of date data are cleared 411. If the process is successful the process continues, otherwise an error email is emailed to the error notification list for attention 412.

8. New data is imported 413 into the newly emptied tables. If the process is successful the process continues, otherwise an error email is emailed to the error notification list for attention.

9. Fields that will be subjected to the metaphonic search are run through the metaphonic function 417 to return a metaphonic token 415. That metaphonic token is stored persisted in the database with the new data, or with related records. If the process is successful the process continues to completion, otherwise an error email 416 is emailed to the error notification list for attention.

10. When all the new records have been assigned a metaphonic key, the process is complete 418.

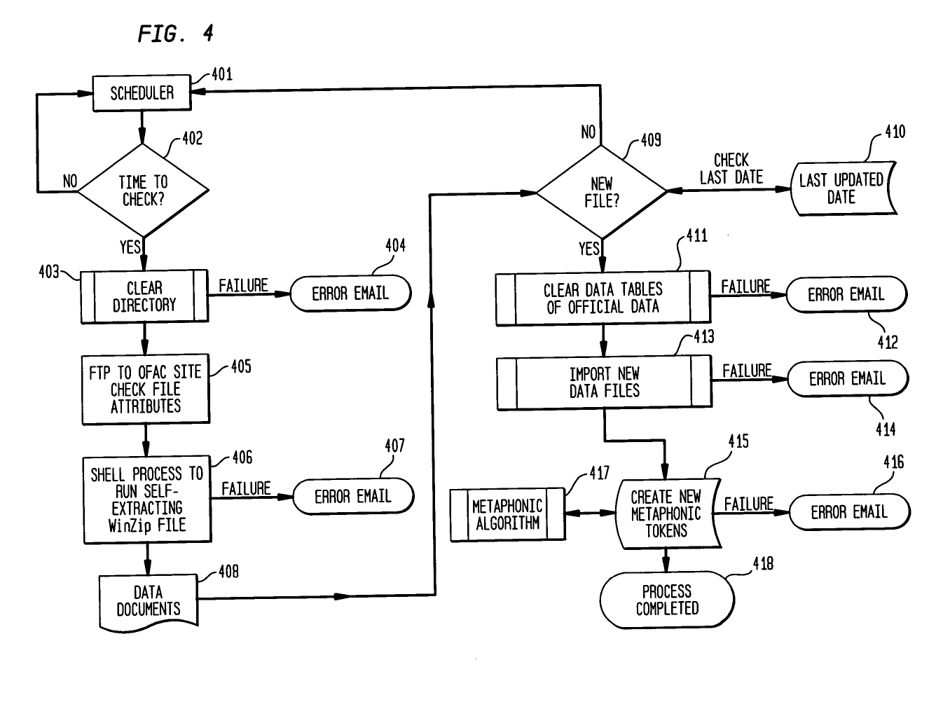

FIG. 5 is a basic flow diagram that illustrates how the invention responds to a user or system consuming the service to match a single submitted entity. The steps are:

1. A user enters a name 501 or string of characters that represents his/her best estimation of how that word would be spelled. An affirmative action such as, but not limited to, a mouse-click or key press, activates the pre-processing of the submission.

2. The string of characters is cleared of non-alphabetical characters, parsed along its spaces into separate words and placed in an array 502.

3. Each element of the array is submitted to the metaphonic algorithm to produce a token. These tokens are stored in an array.

4. A filter statement such as a Structured Query Language statement is constructed using the metaphonic tokens 503. This query string uses conjunctions and wildcards so token order and fragments do not defeat an effective search against the tokens persisted in the database 504.

5. The filter is joined with a larger string that defines the elements of the displayed result set and its sorting order and any potential relationships with other data stores 505.

6. The system checks the customer profile to determine if the user subscribes to an enhanced list 507. If the user subscribes to an enhanced list, the query statement is submitted against the enhanced list 508, otherwise, it is submitted against the standard list 506. Any results are held in a variable or persisted to disk (depending on system requirements at the time of the search) as a string that describes the schema and the data 509. The result can be persisted as an XML file.

7. The System checks to see if the user has a proprietary exclusion list 510, which is tokenized in the same manner as the main list. If there is a proprietary exclusion list, the query is submitted against that list in the same manner as it is submitted against the main list 511.

8. Any results are appended to the variable containing the result string 513.

9. The results can be delivered to the user as human readable text such as text composed of ASCII characters (HTML or XML) via HTTP 512.

FIG. 4 is a basic flow diagram that illustrates how the invention responds to a user or system consuming the service to match an entire list of submissions 603. The steps are:

1. Customer produces a prescribed ASCII or XML file out of his customer data stores 602.

2. The ASCII file is uploaded to the server running the System via a standard protocol such as FTP or HTTP 601.

3. Upon receipt of the customer's file, the system puts the file into a que if necessary and reads each submitted record one at a time.

4. The string of characters is cleared of non-alphabetical characters, parsed along its spaces into separate words and placed in an array 604.

5. Each element of the array is submitted to the metaphonic algorithm to produce a token. These tokens are stored in an array 605.

6. A filter statement such as a Structured Query Language statement is constructed using the metaphonic tokens. This query string uses conjunctions and wildcards so token order and fragments do not defeat an effective search against the tokens persisted in the database 606.

7. The filter is joined with a larger string that defines the elements of the displayed result set and its sorting order and any potential relationships with other data stores 607.

8. The System can optionally check to see if the submitted ID (not the name or string submission) is on any special lists. In the case of an OFAC search, the submitted name might be a customer who is known to be good, but has been known to produce false positives. If this customer's ID has been submitted, the System returns to step 3 and reads the next record rather than proceed with processing the pre-approved name.

9. The system checks the customer profile to determine if the user subscribes to an enhanced list 609. If the user subscribes to an enhanced list, the query statement is submitted against the enhanced list 610, otherwise, it is submitted against the standard list 608. Any results are held in a variable or persisted to disk (depending on system requirements at the time of the search) as a string that describes the schema and the data 611.

10. The System checks to see if the user has a proprietary exclusion list 612, which is tokenized in the same manner as the main list. If there is a proprietary exclusion list, the query is submitted against that list in the same manner as it is submitted against the main list.

11. Any results are appended to the variable containing the result string 615.

12. The System checks to see if it is processing the last record 614, if there are more records to be processed it returns to Step 3 601, otherwise it presents the result to the user 616.

13. The results can be delivered to the user as human readable text such as text composed of ASCII characters (HTML or XML) via HTTP.

### Example

Example of a Scheduled Automatic Updater According to the Present Invention:

Once every 15 minutes the Scheduled Automatic Updater, running on a staging server, polls the designated Office of Foreign Assets FTP site looking for changes in the published list of Specially Designated Nationals (SDN). This file is SDALL.exe, a self extracting WinZip file. Downloading the SDALL.exe provides for the most efficient process because the SDALL.exe is compact and the files contained within it are in standard ASCII delimited formats.

When a change in the file's creation date is detected, the staging server executes the following steps in the diagram:

1. Clear Directory—The staging server deletes all files from a designated directory where the new data files will be placed. If this step fails, an alerting email is automatically sent to the system administrator noting that the directory clearing step has failed and the updating process requires human intervention. When the Clear Directory step completes successfully the process moves on to step 2.

2. Download SDALL.exe—Using simple File Transfer Protocol, the Scheduled Automatic Updater downloads the self extracting WinZip File to the staging server. If this step fails, an alerting email is automatically sent to the system administrator noting that the download step has failed and the updating process requires human intervention. When the Download SDALL.exe step completes successfully the process moves on to step 3.

3. Unpack SDALL—An out of process shell session is stared on the staging server to execute the self-extracting WinZip file into the designated directory that was cleared in step 1, creating the SDN Files. If this step fails, an alerting email is automatically sent to the system administrator noting that the Unpack SDALL.exe step has failed and the updating process requires human intervention. When the Unpack SDALL.exe step completes successfully the process moves on to step 4.

4. Clear SDN Tables—All the database tables populated by SDN data are cleared using standard stored procedures issuing Delete from x statements where x is the name of the SDN or related tables. If this step fails, an alerting email is automatically sent to the system administrator noting that the Clear SDN Tables step has failed and the updating process requires human intervention. When the Clear SDN Tables step completes successfully the process moves on to step 5.

5. The Data Pump files are read using a “@” delimiter and entered into their counterpart tables on the database server. If this step fails, an alerting email is automatically sent to the system administrator noting that the Data Pump step has failed and the updating process requires human intervention. When the Data Pump step completes successfully the process is complete and new OFAC Data has been sent to the Universal Server.

### APPENDIX A

HTTP GET, HTTP POST and SOAP invocation code that can be used with the present invention:

Soap

The following is a sample SOAP request and response. The placeholders shown need to be replaced with actual values.

POST/SATCH-n-Mahoney.asmx HTTP/1.1

Host: stephenforte.net

Content-Type: text/xml; charset=utf-8

Content-Length: length

SOAPAction: “http://www.ofacsearch.com/OFACSearch”

<?xml version=“1.0” encoding=“utf-8”?>

<soap:Envelope xmlns:xsi=“http://www.w3.org/2001/XMLSchema-instance”

xmlns:xsd=“http://www.w3.org/2001/XMLSchema”

xmIns:soap=“http://schemas.xinlsoap.org/soap/envelope/”>

<soap:Body>

<OFACSearch xmlns=“http://www.ofacsearch.com/”>

<SearchName>string</SearchName>

</OFACSearch>

</soap:Body>

</soap:Envelope>

HTTP/1.1 200 OK

Content-Type: text/xml; charset=utf-8

Content-Length: length

<?xml version=“1.0” encoding=“utf-8”?>

<soap:Envelope xmlns:xsi=“http://www.w3.org/2001/XMLSchema-instance”

xmlns:xsd=“http://www.w3.org/2001/XMLSchema”

xmIns:soap=“http://schemas.xmlsoap.org/soap/envelope/”>

<soap:Body>

<OFACSearchResponse xmIns=“http://www.ofacsearch.com/”>

<OFACSearchResult>string</OFACSearchResult>

</OFACSearchResponse>

</soap:Body>

</soap:Envelope>

HTTP GET

The following is a sample HTTP GET request and response. The placeholders shown need to be replaced with actual values.

GET/SATCH-n-Mahoney.asmx/OFAC Search?SearchName=string HTTP/1.1

Host:stephenforte.net

HTTP/1.1 200 OK

Content-Type:text/xml; charset=utf-8

Content-Length:length

<?xml version=“1.0” encoding=“utf-8”?>

<string xmlns=“http://www.ofacsearch.com/”>string</string>

HTTP POST

The following is a sample HTTP POST request and response. The placeholders shown need to be replaced with actual values.

POST/SATCH-n-Mahoney.asmx/OFAC Search HTTP/1.1

Host:stephenforte.net

Content-Type:application/x-www-form-urlencoded

Content-Length:length

SearchName=string

HTTP/1.1 200 OK

Content-Type: text/xml;charset=utf-8

Content-Length:length

<?xml version-“1.0” encoding=“utf-8”?>

<string xmlns=“http://www.ofacsearch.com/”>string</string>

What is claimed:

1. A method of generating metaphonic tokens from a text database for word identification and comparison for one or more users comprising the steps of:
providing the text database;
providing the input text;
generating a metaphonic token database by generating a first set of metaphonic tokens from the text database; and
outputting the token database to the users for word identification and comparison.

2. The method of claims 1 wherein providing the text database comprises providing a database of names.

3. The method of claims 1 wherein providing the text database comprises providing the OFAC database.

4. A method of comparing input text including one or more words to a text database including a plurality of words for taking an action comprising the steps of:
providing the text database;
providing the input text;
generating a metaphonic token database by generating a first set of metaphonic tokens from the text database;
generating a second set of metaphonic tokens from the input text;
comparing the metaphonic tokens generated from the input text to the metaphonic tokens representing the text database; and
taking an action based on the results of the comparison.

5. The method of claim 4, wherein providing the text database comprises providing a text database of names.

6. The method of claim 4, further comprising remotely invoking the metaphonic comparison.

7. The method of claim 4, wherein providing the text database comprises providing an updated text database.

8. The method of claim 4, wherein providing a database comprising the OFAC list.

9. The method of claim 4, wherein generating a metaphonic token database comprises generating a metaphonic token database from an updated text database.

10. The method of claim 9, wherein generating a metaphonic token database comprises generating a metaphonic token database by generating a first set of metaphonic tokens from the updated text database.

11. The method of claim 4, wherein providing the text database comprises providing the OFAC text database.

12. The method of claim 4 wherein generating metaphonic tokens comprises:
clearing the text of non-alphabetic characters;
parsing words
reducing to metaphonic tokens; and
placing the tokens in an array.

13. The method of claim 4 wherein taking an action comprises reporting results of the comparison.

14. A computer system for comparing input text to items in a text database comprising:
a database of text items stored on computer media or in computer memory to be compared to;
means for converting each database entry to a metaphonic token;
means for generating and storing metaphonic tokens for each text item in the database; and
means for comparing the stored database text item metaphonic tokens to the metaphonic tokens generated from the input text items.

15. The system of claim 14 wherein the input text items comprise names.

16. The system of claim 14 wherein the input text items comprise human readable text.

17. The system of claim 14 wherein the database comprises a centralized list.

18. The system of claim 17 wherein the centralized list comprises a centralized list updated from an authorized master list.

19. The system of claim 17 wherein the authorized master list comprises the OFAC list.

20. The system of claim 14 wherein the input text comprises a list of text items to be compared to the database.

21. A computer system to compare input text items to a text database comprising:
the text database of text items stored on computer media or in computer memory to be compared to;
a metaphonic token converter for converting the text items to metaphonic tokens;
a database to store the metaphonic tokens generated from the text in the text database; and,
a comparator for comparing the metaphonic tokens generated from the inputted text to the database of stored metaphonic tokens.

22. The system of claim 21 wherein the input text items comprise names.

23. The system of claim 21 wherein the input text items comprise human readable text.

24. The system of claim 21 wherein the text database comprises a centralized list.

25. The system of claim 24 wherein the centralized list is updated from an authorized master list.

26. The system of claim 21 wherein the input text comprises a list of text items to be compared to the database.
